(19) United States
(12) Patent Application Publication
(10) Pub. No.: US 2009/0045587 A1
(43) Pub. Date: Feb. 19, 2009

(54) Camshaft phaser wiper seal

(76) Inventors: Gary J. DeAngelis, Spencerport, NY (US); David J. Ranelli, West Henrietta, NY (US); Amanda M. Weiss, Livonia, NY (US)

Correspondence Address: Paul L. Marshall, Esq.;Delphi Technologies, Inc., Mail Code 480410202, P. O. Box 5052, Troy, MI, 48007, US

(21) Appl. No.: 11/893,529

(22) Filed: Aug. 16, 2007

(51) Int. Cl. F16J 15/00

(52) U.S. Cl. 277/500

(57) ABSTRACT

A wiper seal subassembly for disposal in rotor vanes or stator lobes of a vane-type camshaft phaser comprises a backing spring and a sealing element. The sealing element includes spring retention features that loosely retain the backing spring and that are integrally molded into the sealing element. The spring retention features include undercut retention features, such as an overhanging edge, that prevent the backing spring from vertically detaching from the sealing element. The spring retention features further include sidewall tabs that prevent the backing spring from horizontally detaching from the sealing element. The sealing element is formed from a plastic composite material during an injection molding process using a simple injection mold tooling design. The single-piece wiper seal subassembly is provided at the tip of each rotor vane and/or stator lobe of a vane-type camshaft phaser for varying the timing of combustion valves in an internal combustion engine.

### TECHNICAL FIELD

The present invention relates to hydraulic valve timing devices of internal combustion engines; more particularly, to vane-type camshaft phasers; and most particularly, to a low cost wiper seal subassembly for disposal in rotor vanes and/or stator lobes of a camshaft phaser.

### BACKGROUND OF THE INVENTION

Camshaft phasers for varying the phase relationship between the crankshaft and a camshaft of an internal combustion engine are well known. A prior art vane-type phaser generally comprises a plurality of outwardly extending vanes on a rotor interspersed with a plurality of inwardly extending lobes on a stator, forming alternating advance and retard chambers between the vanes and lobes. Engine oil is supplied via a multiport oil control valve (OCV), in accordance with an engine control module, to either the advance or retard chambers as required to meet current or anticipated engine operating conditions.

In a typical prior art vane-type camshaft phaser, also referred to herein simply as a cam phaser, the tip of each rotor vane and stator lobe is provided with a compressible radial seal for wiping the cylindrical wall of the opposite member, such as the stator wall and/or rotor hub, to prevent leakage around the rotor between the advance and retard chambers. Therefore, wiper seals provide a dynamical seal between two hydraulic chambers, which are pressurized in an alternating fashion.

A first known wiper seal utilizes a two-piece construction consisting of a plastic wiper blade and a backing spring disposed within the vane or lobe to load the wiper blade against the stator or rotor surface. It is difficult and time consuming to reliably install a backing spring that is not fixed to a wiper blade in valve timing adjusting devices, such as a camshaft phaser, since the backing spring may fall out of the wiper blade or it may be difficult to correctly arrange the backing spring relative to the wiper blade. In cases where the wiper blade and the backing spring are fixed to each other by spot welding or screwing to avoid problems of installing two separate parts, an elastic coefficient of the backing spring is increased during insertion into axial directional grooves included in the rotor vane or stator lobe and, consequently, an excessive load may be applied to the backing spring.

For example, U.S. Pat. No. 5,957,098 discloses a wiper blade including portions that receive hooked holes of the backing spring. The wiper blade includes a recess that receives both ends of the backing spring during assembly into the camshaft phaser. In another embodiment, a wavy leaf spring is fixed to the wiper blade by machine screws.

U.S. Pat. No. 6,516,762, for example, discloses a wiper blade that includes protrusive guides that receive slits in foot portions of a backing spring. When the backing spring is fitted to the wiper blade, the protrusive guides fit loosely into the slits. During installation in a camshaft phaser the backing spring slides past the protrusive guides to avoid excessive loading on the spring. A stopper portion formed by ultrasonically deforming an upper end portion of each protrusive guide prevents detachment of the backing spring from the wiper blade.

While these known wiper seals may reliably prevent a backing spring from detaching from a wiper blade without applying a excessive load to the backing spring, secondary machining steps are needed to complete the wiper blade assembly in order to retain the backing spring, and often no preassembly of the wiper blade-backing spring unit is possible.

A second known wiper seal utilizes a two-piece seal disposed in an axially extending groove formed in the vane or lobe tip. Typically, an elastomeric spring is over-molded onto a rigid plastic wiper-shaped substrate. The injection molded wiper-shaped substrate is surface treated to promote adhesion of the elastomer material to it. The elastomeric spring is molded in place onto the substrate during an elastomer insert molding process where the wiper-shaped substrate is exposed to molding pressures and temperatures. This configuration requires two separate manufacturing steps, one successive assembly step, and two different materials to provide a one-piece wiper seal subassembly, creating undesired manufacturing and subassembly costs as well as complexity.

What is needed in the art is a wiper seal subassembly that includes a wiper blade and a backing spring, where features needed to retain the backing spring are integrated in the wiper blade, such that time consuming and expensive secondary machining steps can be eliminated.

What is further needed in the art is a one-piece wiper seal subassembly that is a pre-assembled unit coupling a backing spring with a wiper blade.

It is a principal object of the present invention to reduce the complexity of a wiper seal and to improve the reliability of a wiper seal in a vane-type camshaft phaser.

It is a further object of the present invention to reduce the manufacturing cost of a cam phaser wiper seal, to reduce processing steps and process cycle time, and to reduce the amount of error-proofing needed on the assembly line.

### SUMMARY OF THE INVENTION

Briefly described, a wiper seal subassembly for preventing leakage of oil between advance and retard chambers formed between rotor vanes and stator lobes in a vane-type camshaft phaser in accordance with the invention combines a backing spring and a sealing element in a pre-assembled unit. The wiper seal subassembly is provided at the tip of each rotor vane and/or stator lobe of a vane-type camshaft phaser. The vane-type camshaft phaser includes a rotor having a plurality of vanes disposed in a stator having a plurality of lobes, the interspersion of vanes and lobes defining a plurality of alternating valve timing advance and valve timing retard chambers with respect to the engine crankshaft. During rotation of the rotor within the stator, the tips of the vanes sweep past concave cylindrical walls of the stator, and the tips of the lobes sweep past convex cylindrical walls of the rotor hub. Each vane and lobe tip is provided with an axially extending groove. The wiper seal subassembly in accordance with the invention is disposed in the groove for wiping the opposing wall, such as the stator wall and/or rotor hub. The wiper seal subassembly in accordance with the invention is designed as a potential drop-in replacement for existing prior art wiper seals, thereby eliminating the need for changing the design of the vane and lobe tips.

The wiper seal subassembly in accordance with the invention includes a sealing element having integrated spring retention features. The spring retention features include undercut retention features, such as an overhanging edge, that prevent the backing spring from vertically detaching from the sealing element. The spring retention features further include sidewall tabs that prevent the backing spring from horizontally detaching from the sealing element.

The sealing element in accordance with the invention is formed from a plastic composite material during an injection molding process using a simple injection mold tooling design using a one-piece open-close mold that requires low mold maintenance. The spring retention features are formed during the injection molding process concurrently to form the body of the sealing element.

The backing spring is formed separately from the sealing element. The sealing element and backing spring are subsequently combined to form the wiper seal subassembly in accordance with the invention. The backing spring may be attached to the sealing element using a snap-fit operation or a pinch-release operation. The backing spring may include features that assist such assembly operations. Furthermore, the retention features integrated in the sealing element are designed to facilitate such assembly operations.

By integrally molding spring retention features into the sealing element in accordance with the present invention, the manufacturing costs and assembly cycle time can be reduced compared to prior art wiper seals based on elimination of secondary machining operations, such as ultrasonic deformation, surface treatment, and elastomer insert molding steps. Lower cost materials that may also exhibit better wear characteristics against aluminum can be used in the wiper seal sub assembly in accordance with the present invention compared to prior art wiper seals due to the elimination of material exposure to surface treatment and elastomer insert molding pressures and temperatures. Furthermore, providing the wiper seal subassembly as a pre-assembled one-piece unit in accordance with the invention is beneficial for the assembly of the wiper seal subassembly in a camshaft phaser, since the backing spring is reliably arranged relative to the sealing element and will not become detached form the sealing element during installation in a groove of a rotor vane or stator lobe.

### BRIEF DESCRIPTION OF THE DRAWINGS

The present invention will now be described, by way of example, with reference to the accompanying drawings, in which:

FIG. 1 is an axial-transverse cross-sectional view of a typical prior art vane-type camshaft phaser;

FIG. 2 is an isometric view of a wiper seal subassembly in accordance with a first embodiment of the invention;

FIG. 3 is a plan side view of the wiper seal subassembly shown in FIG. 1 in accordance with the invention;

FIG. 4 is an isometric view of the wiper seal shown in FIG. 1 in accordance with the invention;

FIG. 5 is an isometric view of a wiper seal subassembly in accordance with a second embodiment of the invention;

FIG. 6 is an isometric view of a wiper seal subassembly in accordance with a third embodiment of the invention; and

FIG. 7 is a cross-sectional side view of the wiper seal subassembly shown in FIG. 6 in accordance with the invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DESCRIPTION OF THE PREFERRED EMBODIMENTS

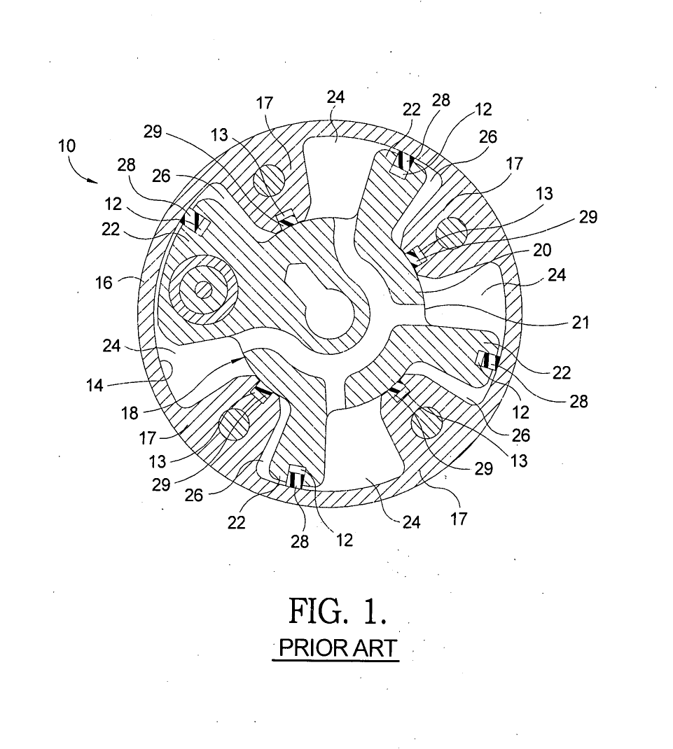

Referring to FIG. 1, an exemplary prior art vane-type camshaft phaser 10 for advancing and retarding the timing of valves of an internal combustion engine includes well-known generic components: a stator 16 having a plurality of inwardly extending lobes 17; a rotor 18 having a cylindrical hub 20 and a plurality of outwardly extending vanes 22; and a plurality of advance chambers 24 and retard chambers 26 being formed between the rotor vanes 22 and the stator 16. The lobes 17 are circumferentially spaced apart for receiving rotor 18. Vanes 22 extend into spaces between lobes 17. Hydraulic advance chambers 24 and retard chambers 26 are thus formed between lobes 17 and vanes 22. Each rotor vane 22 is provided with an axial groove 12 along the vane tip for receiving a resilient seal element 28 for sealingly wiping a cylindrically concave inner wall 14 of stator 16. Likewise, each stator lobe 17 is provided with an axial groove 13 along the lobe tip for receiving a resilient seal element 29 for sealingly wiping a cylindrically convex outer wall 21 of the rotor hub 20. Consequently, seal element 28 and seal element 29 prevent leakage of oil between advance chambers 24 and retard chambers 26.

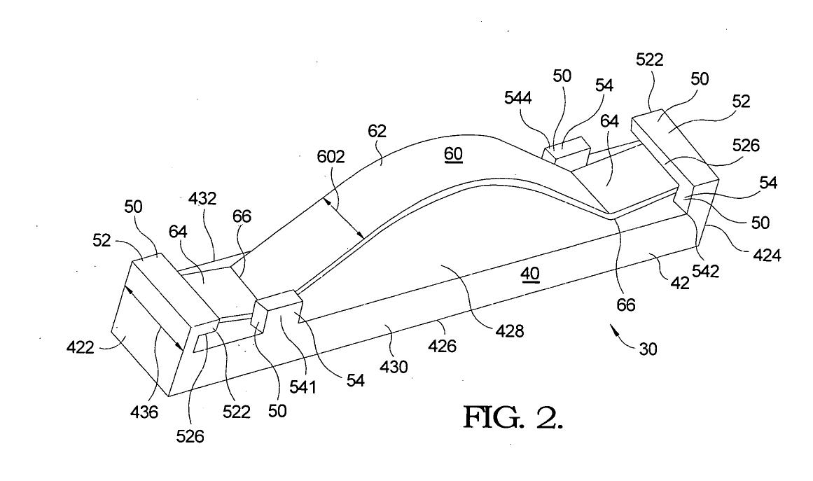

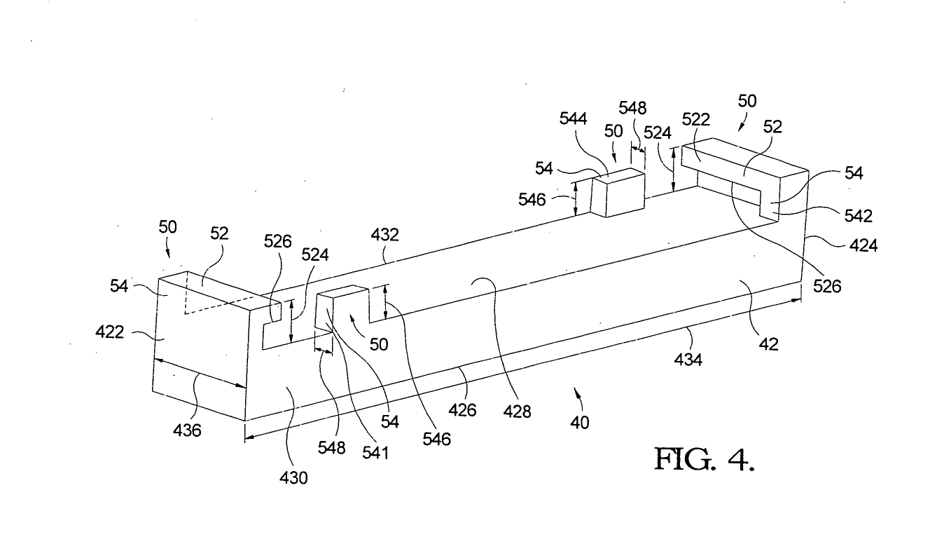

Referring to FIGS. 2 through 4, a wiper seal subassembly 30 in accordance with a first embodiment of the invention for disposal in rotor vanes and/or stator lobes of a vane-type camshaft phaser, such as camshaft phaser 10 shown in FIG. 1, is shown. It should be recognized that wiper seal subassembly 30, as well as alternate designs 70 and 80 of wiper seal subassembly 30, disclosed herein are equally suitable as a direct replacement for either of prior art vane seal element 28 or prior art lobe seal element 29 without modification of prior art vane groove 12 and prior art lobe groove 13 in accordance with the invention as described herein below.

The wiper seal subassembly 30 includes a sealing element 40 and a backing spring 60. Sealing element 40 includes a body 42 that extends longitudinally from a first end 422 to a second end 424 for a length 434, that extends transversely from a front edge 430 to a back edge 432 for a width 436, and that has an outer surface 426 and an inner surface 428. Body 42 may have a generally rectangular cross-section in horizontal direction and a generally rectangular cross-section in vertical direction, wherein the cross-section in horizontal direction has a larger area than the cross-section in vertical direction. Thus, body 42 has a width that is larger than its height. In a typical application in a vane-type camshaft phaser, such as camshaft phaser 10, sealing element 40 is used as a wiper blade where the outer surface 426 sealingly wipes a cylindrically concave wall 14 of stator 16 and/or cylindrically convex outer wall 21 of rotor hub 20, as shown in FIG. 1.

Sealing element 40 includes spring retention features 50. Spring retention features 50 include undercut retention features 52, such as an overhanging edge 522, that prevent backing spring 60 from vertically detaching from sealing element 40. Spring retention features 50 further include sidewall tabs 54 that prevent backing spring 60 from horizontally detaching from sealing element 40 and from rotating out of undercut retention features 52.

All spring retention features 50 extend vertically from inner surface 428 of body 42. One of the undercut retention features 52 and, therefore, one of the overhanging edges 522, is positioned proximate to the first end 422 and the second end 424 of body 42. Undercut retention features 52 have a height 524 and preferably extend from the front edge 430 to the back edge 432 of body 42. Under cut 526 is shown in FIGS. 2 through 4 to be straight. Sidewall tabs 54 have a height 546 and are preferably positioned proximate to the front edge 430 and proximate to back edge 432. The height 546 of sidewall tabs 54 may be equal or smaller than the height 524 of undercut retention features 52. At the front edge 430, a first sidewall tab 541 may be positioned at a distance from the first end 422 of body 42 and a second sidewall tab 542 may be positioned proximate to said second end 424 filling a space under undercut retention feature 52. At the back edge 432, a third sidewall tab 543 may be positioned proximate to first end 422 filling a space under undercut retention feature 52 and a fourth sidewall tab 544 may be positioned at a distance from the second end 424 of body 42. Sidewall tabs 541 and 544 are shown in FIGS. 2 through 4 to have a rectangular shape. Sidewall tabs 54 have a width 548 that is smaller than half the width 436 of body 42. Width 548 is chosen such that backing spring 60 can be retained loosely.

In a currently-preferred method of manufacturing, sealing element 40 is formed from a plastic composite material, such as the thermoplastic compound polyphthalamide (PPA). PPA is a thermoplastic synthetic resin of the nylon family suitable for high temperature applications. PPA is a high performance polyamide having a modulus higher than 1000 kpsi (kilo pound per square inch), and inheriting good high-temperature dimensional stability. PPA is classified as engineering plastic and is commercially available from a variety of suppliers. Although, PPA is a presently preferred material, it is understood that other materials may be used. The material used to manufacture sealing element 40 should be selected according to wear characteristics, stress and strain capabilities, ductility, and flexibility. Since sealing element 40 is operated at elevated temperatures, maximum dimensional stability and, therefore, minimum post-mold shrinkage is essential. To insure that no dimensional bias is introduced by moisture, sealing element 40 should contain less than about 0.3% moisture by weight when measured.

Sealing element 40 is preferably manufactured during an injection molding process. Spring retention features 50 are integrally molded into sealing element 40 during the injection molding process. No further manufacturing steps are needed to form sealing element 40 with integrated spring retention features 50. Sealing element 40 is designed such that a simple injection mold tooling design can be used. A one-piece open-close mold without additional slide mechanisms is used to form sealing element 40 with integrated spring retention features 50.

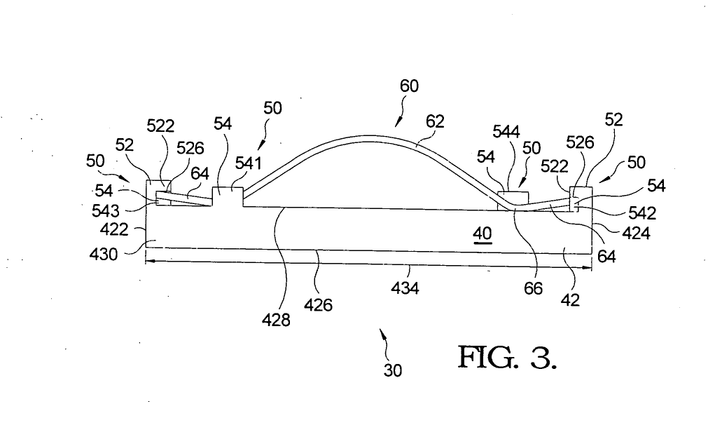

Referring to FIGS. 2 and 3, backing spring 60 is preferably a leaf spring and includes a central section 62 and a pair of foot sections 64 positioned at both ends of central section 62. Central section 62 of backing spring 60 is formed in an arc. When inserted in spring retention feature 50 of the sealing element, both ends of central section 62 are in contact with inner surface 428 of body 42. The contact areas are also transition areas 66 from central section 62 to the foot sections 64. Backing spring 60 has a width 602 that is smaller than the width 436 of body 42 of sealing element 40. The width 602 may be constant over the entire length of spring 60, as shown in FIG. 2. Both foot sections 64 may extend from transition area 66 at an angle. The length of spring 66 is chosen such that both foot sections 64 reach underneath undercut retention features 52. Once backing spring 60 is inserted into sealing element 40, both foot sections 64 of backing spring 60 are retained below the pair of overhanging edges 522. First sidewall tab 541 and fourth sidewall tab 544 are positioned at transition area 66 at opposite edges of body 41 of sealing element 40. Sidewall tabs 54 assist holding backing spring 60 in place on inner surface 428 of sealing element 40. Spring retention features 50 are designed to loosely retain backing spring 60 such that backing spring 60 is able to longitudinally expand during installation, but not to retain backing spring 60 rigidly.

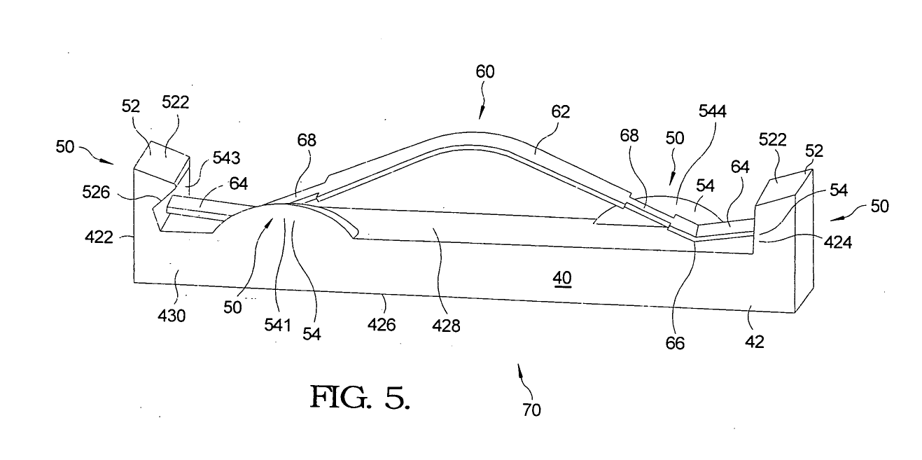

Backing spring 60 is formed separately from the sealing element. Backing spring 60 is preferably a metal spring. Sealing element 40 and backing spring 60 are subsequently combined to form wiper seal subassembly 30. When installed in rotor vanes and/or stator lobes of a vane-type camshaft phaser, such as camshaft phaser 10 shown in FIG. 1, backing spring 60 provides a sealing pressure to sealing element 40. Backing spring 60 may be inserted into sealing element 40 by a snap and fit operation, where backing spring 60 is pushed into spring retention features 50 in a vertical direction. To support this installation operation, overhanging edge 522 may be designed as an angled lead-in, as shown in FIG.5.

Backing spring 60 may further be inserted into sealing element 40 by a pinch and release operation, where backing spring 60 is first pinched longitudinally inward, then moved towards body 42 of sealing element 40 past undercut retention features 52, and then released. To support this installation operation as well as general handling of backing spring 60, backing spring 60 may include cutouts 68 in central section 62, preferably positioned close to transition areas 66, as shown in FIG. 5, to facilitate inward pinching of the backing spring.

Referring now to FIG. 5, wiper seal subassembly 70, an alternative design of wiper seal subassembly 30, is shown according to a second embodiment of the invention. As can be seen, overhanging edge 522 of undercut retention feature 52 is designed as an angled lead in. Furthermore, the undercut 526 of the undercut retention feature 52 is angled to assist focusing backing spring 60 in position. First sidewall tab 541 and fourth sidewall tab 544 are shown to have a circular shape and to extend along edges 430 and 432, respectively, for a longer distance than sidewall tabs 541 and 544 shown in FIGS. 2 through 4.

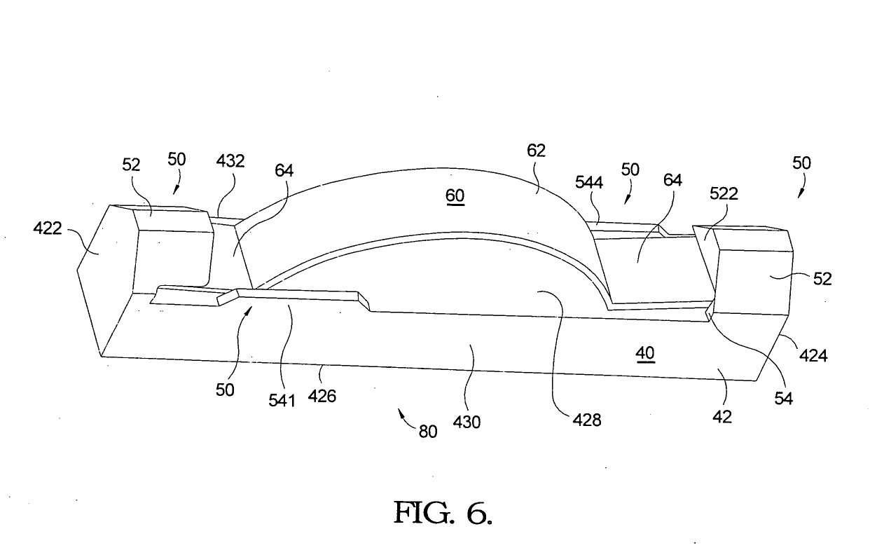

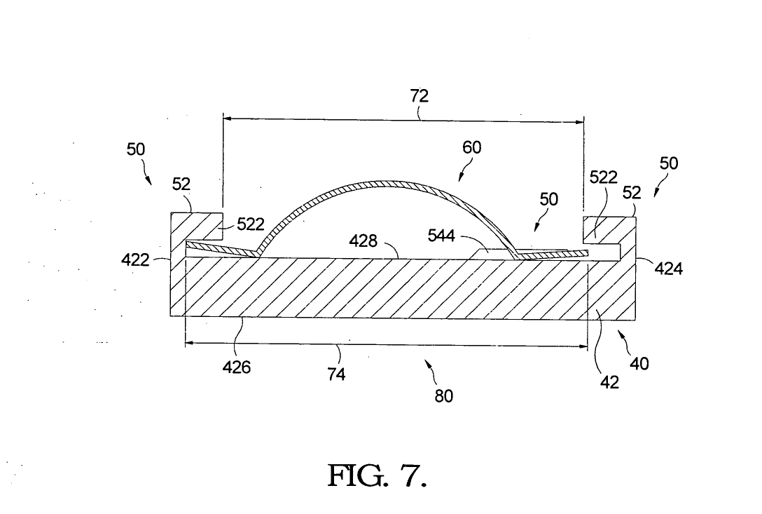

Referring now to FIGS. 6 and 7, wiper seal subassembly 80, an alternative design of wiper seal subassembly 30, is shown according to a third embodiment of the invention. First sidewall tab 541 and fourth sidewall tab 544 are shown to have a: polygonal shape and to extend along edges 430 and 432, respectively, for a longer distance than sidewall tabs 541 and 544 shown in FIGS. 2 through 4. Undercut retention features 52 have a hexagonal cross-section contrary to the rectangular cross-section shown in FIGS. 2-4, which results in material savings.

As can be seen in FIG. 7, the inside length 72 between the undercut retention feature 52 at first end 422 and the opposite undercut retention feature 52 at second end 424 is smaller than the length 74 of relaxed backing spring 60 to prevent backing spring 60 from disengaging from sealing element 40 after insertion of backing spring 60 into sealing element 40.

Backing spring 60 including cutouts 68 in central section 62, as shown in FIG. 5, may be used in wiper seal subassemblies 30 and 80, while backing spring 60 having a constant width 602, as shown in FIGS. 2 and 6, may be used in wiper seal subassembly 70. Furthermore, all other shown alternative features may be applicable to any of the shown wiper seal subassembly configurations.

In some camshaft phasers, wiper seals are required on only the rotor vanes and are omitted from the stator lobes. Such phasers are fully comprehended by the present invention.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A wiper seal subassembly for disposal in rotor vanes or stator lobes of a vane-type camshaft phaser, comprising:
a backing spring; and
a sealing element including spring retention features integrally molded into said sealing element, said spring retention features including undercut retention features that prevent said backing spring from vertically detaching from said sealing element and sidewall tabs that prevent said backing spring from horizontally detaching from said sealing element and from rotating out of said undercut retention features;
wherein said spring retention features loosely retain said backing spring prior to disposal in said vane-type camshaft phaser.

2. The wiper seal subassembly in accordance with claim 1, wherein said sealing element includes a body having an outer surface and an inner surface, wherein said outer surface sealingly wipes a cylindrical concave wall of a stator or a cylindrical convex outer wall of a rotor hub, and wherein said spring retention features extend vertically from said inner surface.

3. The wiper seal subassembly in accordance with claim 1, wherein said backing spring provides a sealing pressure to said sealing element.

4. The wiper seal subassembly in accordance with claim 1, wherein said sealing element includes a body that extends longitudinally from a first end to a second end and transversely from a front edge to a back edge, wherein a first undercut retention feature is positioned proximate to said first end, wherein a second undercut retention feature is positioned proximate to said second end, and wherein said sidewall tabs are positioned along said front edge and along said back edge.

5. The wiper seal subassembly in accordance with claim 1, wherein a first sidewall tab is positioned along said back edge filling a space under said first undercut retention feature, wherein a second sidewall tab is positioned along said front edge filling a space under said second retention feature, and wherein at least one additional sidewall tab is positioned along said front edge and along said back edge.

6. The wiper seal subassembly in accordance with claim 1, wherein said spring retention features include overhanging edges positioned at opposite ends of said sealing element.

7. The wiper seal subassembly in accordance with claim 1, wherein said sealing element is formed from a plastic composite material during an injection molding process, and wherein said spring retention features are integrally molded into said sealing element during said injection molding process.

8. The wiper seal subassembly in accordance with claim 1, wherein said spring retention features include angled lead-ins that support a snap-fit installation operation when inserting said backing spring into said sealing element.

9. The wiper seal subassembly in accordance with claim 1, wherein said backing spring includes cutouts that support a pinch-release installation operation when inserting said backing spring into said sealing element.

10. A vane-type camshaft phaser for advancing and retarding the timing of valves of an internal combustion engine, comprising:
a first phaser element including an axial groove along the tip thereof; and
a wiper seal subassembly disposed in said axial groove, said wiper seal subassembly including a backing spring and a sealing element, said sealing element including spring retention features including undercut retention features that prevent said backing spring from vertically detaching from said sealing element and sidewall tabs that prevent said backing spring from horizontally detaching from said sealing element and from rotating out of said undercut retention features, said spring retention features integrated into said sealing element and loosely retaining said backing spring prior to disposal in said axial groove;
wherein said wiper seal subassembly is inserted into said groove said backing spring facing said groove, and wherein said backing spring is compressed such that said sealing element makes contact with an opposing wall of a second phaser element.

11. The vane-type camshaft phaser according to claim 10, wherein said first phaser element is selected from the group consisting of rotor vane and stator lobe, and wherein said second phaser element is selected from the group consisting of stator wall and rotor hub.

12. The vane-type camshaft phaser according to claim 10, wherein said spring retention features include a pair of undercut retention features positioned at opposite ends of said sealing element and a plurality of sidewall tabs positioned alternating along opposite edges of said sealing element.

13. The vane-type camshaft phaser according to claim 10, wherein said sealing element is formed from polyphthalamide during an injection molding process, and wherein said spring retention features are integrally molded into said sealing element during said injection molding process.

14. The vane-type camshaft phaser according to claim 10, wherein a one-piece open-mold is used to form said sealing element including said spring retention features.

15. The vane-type camshaft phaser according to claim 10, wherein said backing spring is a leaf spring formed of metal and separately from said sealing element, wherein said leaf spring includes a central section formed in an arc and a pair of foot sections positioned at both ends of said central section, and wherein both ends of said central portion contact said sealing element.

16. The vane-type camshaft phaser according to claim 15, wherein said foot sections are retained below a pair of overhanging edges positioned at both ends of said sealing element.

17. A method for manufacturing a wiper seal subassembly for preventing leakage of oil between advance and retard chambers formed between rotor vanes and stator lobes in a vane-type camshaft phaser, comprising the steps of:
injection molding a sealing element including a pair of undercut retention features and a plurality of sidewall tabs from a plastic composite material;
forming a leaf spring from a metal; and
inserting said spring into said sealing element forming a one-piece wiper seal subassembly.

18. The method according to claim 17, further including the steps of:
using a one-piece open-close mold to form said sealing element with said undercut retention features and said sidewall tabs; and
forming said sealing element from polyphthalamide.

19. The method according to claim 17, further including the steps of:
forming said leaf spring to include a pair of cutouts;
grabbing said spring at said cutouts and pinching said spring;
releasing said spring below said undercut retention features;
preventing said spring from vertically detaching from said sealing element with said undercut retention features; and
preventing said spring from horizontally detaching from said sealing element with said sidewall tabs.
